(19) United States
(12) Patent Application Publication
(10) Pub. No.: US 2010/0223822 A1
(43) Pub. Date: Sep. 9, 2010

(54) IDENTIFICATION DEVICE FOR ELECTRICAL LINES

(75) Inventor: Andreas Wieneke, Lemgo (DE)

Correspondence Address: LAUBSCHER & LAUBSCHER, P.C., 1160 SPA ROAD, SUITE 2B, ANNAPOLIS, MD, 21403, US

(73) Assignee: WEIDMUELLER INTERFACE GMBH & CO. KG, Detmold (DE)

(21) Appl. No.: 12/675,320

(22) PCT Filed: Aug. 26, 2008
(86) PCT No.: PCT/EP08/61154

§ 371 Date: Feb. 25, 2010

(30) Foreign Application Priority Data
Sep. 7, 2007 (DE) 20 2007 012 604.2

(51) Int. Cl. G09F 3/16

(52) U.S. Cl. 40/316

(57) ABSTRACT

An identification marker for an insulated electrical conductor includes a horizontal generally-rectangular rigid support plate having first and second end portions, and an upper surface on which is arranged a conductor support for supporting a conductor transversely of the support plate. A resilient generally-flexible clamping lever is pivotally connected at one end with one end of the support plate for displacement from an open released position toward a clamping position in which a clamping pad on an intermediate portion of the lever engages the circumferential surface of the conductor, thereby to clamp the conductor against the conductor support. A locking arrangement serves to lock the free end of the clamping lever to the support plate. The clamping lever includes a plurality of angularly arranged sections such that the effective length of the lever varies in accordance with the diametric size of the conductor supported on the support plate.

### REFERENCE TO RELATED APPLICATIONS

This application is a continuation application of the International application No. WO 2009/033946 A3 based on the PCT application No. PCT/EP2008/061154 filed Aug. 26, 2008, based on the German application No. DE 20 2007 012 604.2 filed Sep. 7, 2007. This application is related to the inventor's companion application S/N ______ filed ______ entitled “Identification Device for Electrical Conductors” [Attorney's Case No. 19974]

### BACKGROUND OF THE INVENTION

1. Field of the Invention

An identification marker for an insulated electrical conductor comprises a horizontal generally-rectangular rigid support plate having first and second end portions, and an upper surface on which is arranged a conductor support for supporting a conductor transversely of the support plate. An elastic flexible variable-length clamping lever is pivotally connected at one end with one end of the support plate for displacement from a released position toward a clamping position in which a clamping pad on an intermediate portion of the lever engages the circumferential surface of the conductor, thereby to clamp the conductor against the conductor support. Locking means serve to lock the free end of the clamping lever to the support plate.

2. Description of Related Art

It is known in the prior art to provide marking and identification devices including a support plate provided in its middle area with a joint so that the areas located on either side of the joint can be moved into an angular relationship. A seat for the conductor or power line is provided in the manner of a clamp on the side facing away from the pressure lever. If the pressure lever is locked with the support plate, then the clamp-like seat is closed so that the inserted conductor will be fixed or so that the marking device will be fixed upon the power conductor.

In another marking device, the support plate is also provided in the middle area with a joint, but the lateral areas are provided with undercut bridges. When the support plate is in a level position, one can insert a level plate from the side between the undercut bridges so that the marking device is thus fixed or fastened upon the power line.

Due to the clamps constituting the cable seat, the structural height of these previously known marking devices is relatively great so that corresponding installation spaces are necessary, which, however, frequently are not present in the electrical installations because the latter usually have a plurality of electrical power lines.

### SUMMARY OF THE INVENTION

Accordingly, according to a primary object of the invention, an identification marker for an insulated electrical conductor includes a horizontal generally-rectangular rigid support plate having first and second end portions, and an upper surface on which is arranged conductor support mean for supporting a conductor transversely of the support plate, and a resilient generally-flexible variable-length clamping lever pivotally connected at one end with one end of the support plate for displacement from a released position toward a clamping position in which a clamping pad on an intermediate portion of the lever engages the circumferential surface of the conductor, thereby to clamp the conductor against the conductor support.

According to a more specific object of the invention, a locking arrangement serves to lock the free end of the clamping lever to the support plate, use being made of a locking projection that extends vertically upwardly from the support plate, said locking projection having an inclined cam surfaces that is directed at an acute angle downwardly and outwardly, such that a locking bar on the clamping lever rides downwardly on the cam surface to effect expansion of the clamping lever to cause the effective length thereof to correspond with the diameter of the conductor being clamped to the support plate.

Another object is to provide a variable-length clamping lever having a plurality of angularly arranged sections such that the effective length of the lever varies accordion-style in accordance with the diametric size of the conductor supported on the support plate.

A further object of the invention is to design a marking device of the initially described manner in further detail that the structural height, when compared to the known models, will be reduced when the pressure lever is locked with the support plate. This problem is solved in that the power line seat with relation to the locked condition of the pressure lever is arranged on the internal side of the support plate that faces the pressure lever and that at least the pressure lever is made flexibly elastic. The pressure lever can now be so designed that the least possible structural height can be achieved in a state when it is locked with the support plate. Since it is elastically flexible, the marking device can also be firmly clamped upon the electrical power lines with differing diameters. Because the support plate and the pressure lever constitute an integral plastic molded part, particularly economical production is made possible with a correspondingly designed tool by using the injection molding method. Although the support plate could also be flexibly elastic, in the preferred embodiment, however, it is provided that it is made strongly resistant to bending. It is furthermore provided that the power line seat be provided in the middle area of the support plate. This, in turn, promotes the elastic deformation of the pressure lever in the locked state because the intervals between the power line seat and the lateral edges of the pressure lever will be as large as possible.

It is furthermore provided that the insulate conductor or power line seat consist of at least two seat prisms that are arranged in spaced relation from each other. The surfaces that contact the inserted electrical power line then are positioned at an obtuse angle with respect to each other so that optimum prerequisites are provided for the placement of the marking device upon electrical power lines with differing diameters. Furthermore, the seat prisms are so shaped that after firmly clamping upon the electrical power line, the latter will run parallel to and at an interval from the swing axis of the pressure lever.

It is furthermore provided that the clamping lever be fixed upon the support plate by means of a hinge, preferably a film hinge. This support plate has four corners and the longitudinal sides are definitely longer than the lateral edges. The hinge is placed against or molded upon a lateral edge and the catch elements of the support plate and the clamping lever are so placed against or molded upon the opposite lateral edge.

To make sure that the clamping lever for the elastic deformation with respect to the different diameters of the electric power lines be sufficiently deformable, but that, however, the pressure force acting upon the electrical power line will be sufficient, it is provided that the clamping lever has a pressure piece that reinforces the pressure lever in a position that is correct with respect to the power line seat. As a result, the clamping lever is only slightly elastically deformable in that area, if at all. To make sure that the elastic deformation of the pressure lever in areas adjoining the pressure piece be made possible without the application of particularly strong forces, it is provided that the pressure lever in the areas adjoining the pressure piece be provided, at least on one longitudinal side, with a recess so that the width can be reduced with respect to the terminal areas.

To lock the pressure lever with the support plate, it is furthermore provided that on the support plate on the side opposite the hinge, there be molded on at least one catch nose that is arranged on the side that has the power line seat.

It is furthermore provided that for the sake of the elastic deformation of the terminal area of the pressure lever located facing away from the hinge for the purpose of locking with the support plate, this terminal area has an opening. It is furthermore provided that the outer external marginal area adjoining the opening have a catch recess for the purpose of locking in which recess the catch nose, placed against or molded upon the support plate, can engage in a locking manner.

For adaptation to the differing diameters of the electric power lines, the clamping lever on either side of the clamping pad several includes angularly-arranged accordion-type sections. This facilitates adequate elastic deformation for all diameters so that the clamping forces will suffice and so that the marking device will not be shifted around.

It is furthermore still provided that the catch nose be undercut, which catch nose is undercut by the catch recess when the marking device is in the locked position and that the surface of the catch nose facing away from the hinge be made as an oblique surface, whereby the angle formed with the support plate is an acute angle that is preferably less than 90°. It is furthermore provided that the oblique surface forms a cam surface. This results in an advantage to the effect that, especially in the case of power lines with a relatively large diameter, the catch edge forming the catch recess will be pushed along that surface. The catch nose is furthermore so made that the force which a power line exerts on the pressure piece will pull the pressure lever into the catch nose, resulting in secure locking action. The catch nose is undercut so that this locking action will be secured against unintentional opening.

### BRIEF DESCRIPTION OF THE DRAWINGS

Other objects and advantages of the invention will become apparent from a study of the following specification, when viewed in the light of the accompanying drawing, in which:

FIGS. 1 and 10 are top and bottom perspective views, respectively, of the marking device of the present invention, with the clamping lever in the fully released position;

FIG. 2 is a side elevation view of the apparatus of FIG. 1;

FIGS. 3-6 are side elevation views illustrating the steps for clamping an insulated conductor within the marking device of FIG. 1; and

FIGS. 7-9 illustrate the connection of the marking device of FIG. 1 to insulated conductors having different diametric sizes.

### DETAILED DESCRIPTION OF THE INVENTION

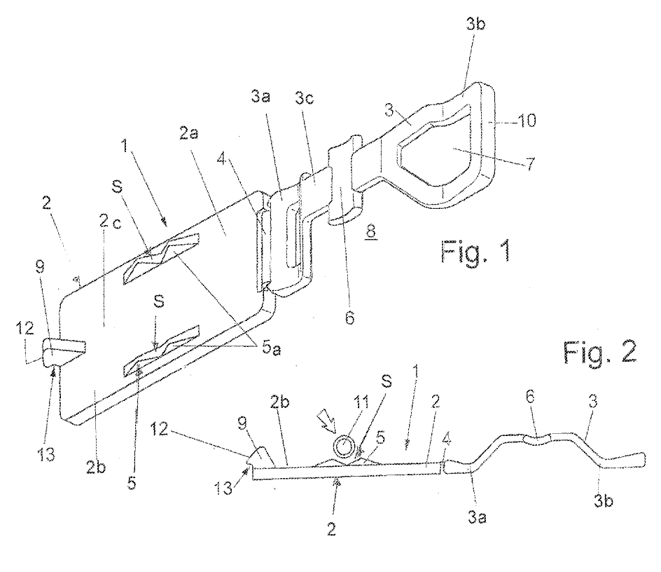

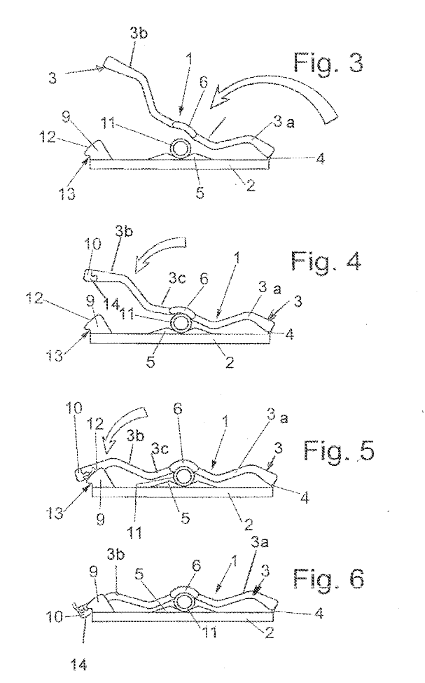

Referring first more particularly to FIGS. 1 and 2, the marking or identification device 1 includes a relatively-rigid generally-rectangular support plate 2 having first and second end portions 2a and 2b, respectively, and an upper surface 2c upon which are mounted support seat means 5 for supporting an insulated conductor 11 (FIG. 2) transversely of the support plate. In the illustrated embodiment, the seat means 5 includes a pair of longitudinally-arranged transversely-spaced prismatic seat members 5a the top walls of which contain aligned obtuse V-shaped slots S for supporting an insulated conductor transversely of the support plate 2.

In order to clamp the conductor to the support seat means 5, a clamping lever 3 formed from a resilient flexible synthetic plastic material is pivotally connected at a first end portion 3a by hinge means 4 to a corresponding first end portion 2a of the support plate. Preferably the hinge means comprises a flexible strip hinge member integral with one or both of the support plate and clamping lever arm members. The clamping lever 3 is pivotally displaceable between the fully released open position of FIGS. 1 and 2 and the fully clamped and locked position of FIG. 6, as will be described in greater detail below. Arranged between the first and second end portions of the clamping lever is an intermediate portion 3c that contains a clamping pad 6 that clamps the insulated conductor in the slots S of the conductor support means 5 when the clamping lever is in the clamped and locked condition of FIG. 6. A recess 8 is provided in one longitudinal side of the clamping lever, thereby to cause the width of the intermediate portion 3c to be less than the widths of the end portions 3a and 3b.

In order to lock the clamping lever second end portion 3b to the corresponding second end portion 2b of the support plate, the support plate is provided with an integral upwardly-directed locking pedestal 9 having a vertical end wall remote from the hinge means 4 that contains a locking notch 13. The upper extremity of this vertical end wall has a tapered cam surface 12 that is inclined downwardly at an acute angle relative to a vertical plane extending transversely of the support plate. The second end 3b of the clamping lever contains an opening 7 that defines a locking bar 10 that extends transversely of the support plate. As will be described below, the clamping bar 10 is operable to engage the notch 13 when the clamping lever is in the clamping, locked condition of FIG. 6. It is important to note that each of the clamping lever end portions has a generally V-shaped longitudinal cross-sectional configuration that is upwardly directed when the lever is in the open released position of FIG. 2, whereby the effective length of the resilient lever may be varied in an accordion-style manner.

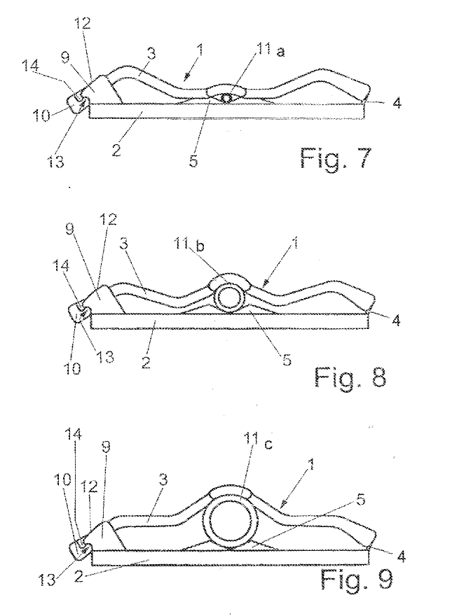

Referring now to FIGS. 3-6, in order to clamp in place transversely of the support plate an insulated conductor 11 seated on the aligned slots S of the conductor support means 5, the clamping lever is pivoted upwardly in the counter-clockwise direction about the pivot axis defined by the hinge means 4 (FIG. 3) until the clamping pad portion 6 engages the circumferential surface of the conductor (FIG. 4). Upon further displacement of the second end portion 3b toward the position of FIG. 5, the locking bar 10 engages the cam surface 12 on the locking pedestal 9, thereby rolling the clamping pad 6 and the intermediate lever portion 3c toward the illustrated position, and expanding the effective length of the flexible resilient clamping lever 3. Upon further bending of the second lever portion 3b about the circumferential surface of the conductor 11, the locking lip 14 of the locking bar 10 is snapped into the locking notch 13, thereby to firmly clamp the conductor 11 to the conductor seat means 5.

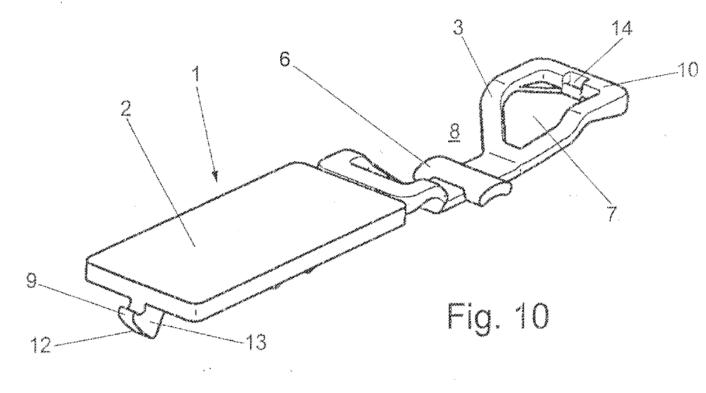

As shown in FIGS. 7-9, the marking or identification device 1 of the present invention is suitable for use with insulated conductors having different diametric dimensions. In the case of the small diameter conductor 11 a of FIG. 7, very little elastic deformation of the clamping lever is required to clamp the conductor to the support seat means. In the case of a medium-sized conductor 11b as shown in FIG. 8, a greater elastic deformation of the clamping lever is produced. Finally, in the case of a large-diameter conductor 11c shown in FIG. 9, a substantial extent of deformation of the clamping lever is produces as the locking bar 10 slides down the inclined cam surface 12 toward engagement with the notch 13.

The invention is not confined to the illustrated exemplary embodiment. The essential thing is that the conductor seat 5 for electric conductor 11, related to the locked state of pressure lever 3, be arranged on the inside of support plate 2, whereby pressure lever 3 is made elastically flexible.

While in accordance with the provisions of the Patent Statutes the preferred forms and embodiments of the invention have been illustrated and described, it will be apparent to those skilled in the art that changes may be made without deviating from the invention described above.

What is claimed is:

1. An identification marker for an insulated electrical conductor, comprising:
(a) a horizontal generally-rectangular rigid support plate (2) having first (2a) and second (2b) end portions, and an upper surface (2c);
(b) conductor support seat means (5) arranged on said support plate upper surface intermediate the ends thereof for supporting transversely of said support plate one of a plurality of conductors having diameters of different sizes (11a; 11b; 11c);
(c) an elastic generally-flexible clamping lever (3) having first (3a) and second (3b) end portions arranged on opposite sides of an intermediate portion (3c),
(1) said clamping lever having an effective length that is at least as great as the length of said support plate:
(2) said clamping lever intermediate portion including a clamping pad portion (6);
(d) pivot means (4) pivotally connecting said support plate first end portion with said clamping lever first end portion, said clamping lever being pivotally displaceable in a given direction from a released position remote from said conductor support means toward a clamping position in which said clamping pad portion clamps the conductor into engagement with said conductor support means; and
(e) locking means (9, 10) for locking said clamping lever in said clamping position.

2. An identification marker as defined in claim 1, wherein said locking means is operable to lock together the second ends of said support plate and said clamping lever.

3. An identification marker as defined in claim 2, wherein said clamping lever includes on opposite sides of said clamping pad portion first (3a) and second (3b) arm portions adjacent and remote from said pivot means, respectively,
(1) said clamping lever being initially pivotable in said given direction from said released position toward an intermediate position in which said clamping pad portion is in engagement with the circumferential surface of the conductor;
(2) said clamping lever second arm portion being subsequently bendable, relative to said clamping pad portion and said first arm portion, in said given direction about the conductor circumferential surface toward a locking position adjacent said support plate second end portion;
(3) said locking means being operable to lock said clamping lever second arm portion in said locking position.

4. An identification marker as defined in claim 3, wherein said locking means includes:
(1) a locking projection (9) extending upwardly from the upper surface of said support plate second end;
(2) said locking projection having a vertical wall remote from said pivot means that contain a locking notch (13);
(3) said clamping lever second arm portion containing an opening (7) that defines a transversely-extending locking bar portion (10) adjacent the free extremity of said clamping lever second arm portion, said locking bar portion including a catch lip (14) arranged to extend into locking engagement within said locking notch when said clamping lever second end portion is bent toward said locking position.

5. An identification marker as defined in claim 4, wherein said locking projection vertical wall terminates at its upper end above said locking notch in an angularly-arranged cam surface (12) that diverges downwardly at an acute angle in a direction away from said support plate first end.

6. An identification marker as defined in claim 5, wherein at least one of said clamping lever arms has a generally V-shaped longitudinal cross-sectional configuration, whereby the effective length of the clamping arm corresponds with the diametric size of the insulated conductor.

7. An identification marker as defined in claim 3, wherein said conductor support seat means includes at least one longitudinally-arranged seat member extending upwardly from said support surface, said seat member containing an upwardly-directed obtuse V-shaped slot (S) for receiving insulated conductors of different sizes.

8. An identification marker as defined in claim 3, wherein said pivot means comprises a flexible synthetic plastic hinge strip connected between said support plate and said clamping lever.

9. An identification marker as defined in claim 8, wherein said clamping lever and said support plate are each formed from a synthetic plastic material.

10. An identification marker as defined in claim 3, wherein at least one side of said clamping lever contains a recess (8) such that the width of said lever intermediate portion is less than the width of said lever end portions.
